(19) United States
(12) Patent Application Publication
(10) Pub. No.: US 2018/0015522 A1
(43) Pub. Date: Jan. 18, 2018

(54) HIGH-SPEED HOT FORMING AND DIRECT QUENCHING

(71) Applicants: Rasoul Jelokhani Niaraki, Qazvin (IR); Mahdi Soltanpour, Karaj (IR); Ali Fazli, Qazvin (IR)

(72) Inventors: Rasoul Jelokhani Niaraki, Qazvin (IR); Mahdi Soltanpour, Karaj (IR); Ali Fazli, Qazvin (IR)

(73) Assignee: Imam Khomeini International University, Qazvin (IR)

(21) Appl. No.: 15/628,555

(22) Filed: Jun. 20, 2017

(30) Foreign Application Priority Data
Jun. 20, 2016 (IR) 13955014000300375

(51) Int. Cl. B21D 26/14; H01F 7/20; C21D 1/60; H05B 3/02; C21D 1/40

(52) U.S. Cl. CPC B21D 26/14; H05B 3/023; C21D 1/40; C21D 1/60; H01F 7/202

(57) ABSTRACT

A high-speed hot forming and direct quenching method and apparatus are disclosed. A first step of the method can comprise various pre-processing steps that can prepare a workpiece for the apparatus. A second step involves a heat-treatment of the workpiece. A third step comprises hot forming the workpiece and primary quenching of the workpiece. A fourth step can comprise a secondary quenching of the workpiece.

### CROSS REFERENCE TO RELATED APPLICATION

This application claims the benefit of priority to an Iran Application Serial Number 139550140003003750 filed on Jun. 20, 2016, which is incorporated by reference herein in its entirety.

### TECHNICAL FIELD

The present disclosure relates generally to a method and apparatus for forming a metal plate. More specifically, the present application relates to a method and apparatus for high-speed hot forming and direct quenching a metal plate.

### BACKGROUND

Pressing a sheet metal or blank into a desired shape generally involves the application of heat of metallic workpieces prior to operations such as hot forging, rolling, extrusion, and other formations. As an example, some methods of mass producing automobile parts that require high strength employ a hot press-forming method or die quenching method.

### SUMMARY

The present disclosure describes a high-speed hot forming and direct quenching system for metal sheet forming. The high-speed hot forming and direct quenching system includes four steps: a pre-processing step, workpiece heating, hot forming of the workpiece and primary quenching, and secondary quenching of the workpiece.

The high-speed hot forming and direct quenching system includes a workpiece, a die, a fluid chamber, a thermal insulator, an electrical insulator, a fluid, a first inlet, a first outlet, an inert gas, a second inlet, a second outlet, a hole, a first electrode, a second electrode and a third outlet.

In the pre-processing step, the workpiece is placed between the die and the fluid chamber either manually or automatically. By moving the die the workpiece is locked. On both sides of the workpiece there are a thermal insulator and an electrical insulator. The thermal and electrical insulators protect the die from overheating and damage by high temperature and current passing through the workpiece during the process. The insulators should be flexible and be resistive to temperature shocks. After placing the workpiece, a fluid flows into the fluid chamber. A low flux of fluid enters the fluid chamber via a first inlet. The excess fluid exits via a first outlet constantly therefore; the fluid flows continuously and remains at a constant temperature during the heating process. While the fluid flows through the fluid chamber, an inert gas is injected to the space between the fluid and the workpiece through a second inlet to make that space free of oxygen which may damage the workpiece during heating and hot forming and primary quenching processes. The inert gas and the air exit the space between the workpiece and the fluid via a second outlet. In order to suck the oxygen out of the space between the workpiece and the die there is a hole which is attached to a vacuum pump. Thus, in some implementations, the hole is associated with a wall of the fluid chamber, and the hole is further connected to a vacuum pump to conduct air outside of the fluid chamber, thereby minimizing the oxidation during the hot forming and direct quenching processes.

The workpiece heating step may be implemented by different methods, such as induction methods, resistive methods, industrial furnaces etc. In one aspect of the present application, the heating step is a resistive heating step. In this method, both ends of the workpiece are attached to two copper electrodes. The high current enters the first electrode and exits the second electrode and passes through the workpiece. The high electrical resistivity of the workpiece causes the workpiece to become heated. By controlling the duration and the current, desired temperature can be achieved. The temperature of the workpiece is measured by a sensor on the workpiece to avoid overheating. The control system maintains the temperature of the workpiece at the desired temperature at the end of heating step by switching the passing current through the electrode on and off or by controlling the electric current density. The fluid flows during the entire pre-processing step and the heating step to maintain its temperature. The first inlet and the first outlet close just before the hot forming and primary quenching step starts.

The hot forming and primary quenching step follows the heating step. The hot forming and primary quenching step may include rapid movement of the fluid and the inert gas upward. The hydraulic force of the fluid and the inert gas push the workpiece into the die and form the workpiece into the shape of the die. It should be noted that all the inlets and outlets are configured to close shortly before the hot forming and primary quenching step begins.

The hot forming and primary quenching step is followed by the secondary quenching step. During the secondary quenching step, the first inlet and the second inlet and the second outlet open to enter the fluid and the inert gas with high flux. The high flux fluid exits the fluid chamber through a wider outlet for example, the third outlet. The turbulent flow regime of the fluid and the inert gas causes rapid quenching of the workpiece.

### BRIEF DESCRIPTION OF THE DRAWINGS

Features of the subject technology are set forth in the appended claims. However, for purpose of explanation, several implementations of the subject technology are set forth in the following figures.

FIG. 1A illustrates a method of using the disclosed hot forming and quenching system according to an implementation of the instant application;

FIG. 1B illustrates a method of pre-processing according to an implementation of the instant application;

FIG. 1C illustrates a method of heat-treatment according to an implementation of the instant application;

FIG. 1D illustrates a method of hot stamping and primary quenching according to an implementation of the instant application;

FIG. 1E illustrates a method of secondary quenching according to an implementation of the instant application;

FIG. 2 illustrates a schematic of the high-speed hot forming and direct quenching system according to an implementation of the instant application;

FIG. 3 illustrates a hot forming and primary quenching step including an electro-hydraulic force according to an implementation of the instant application;

FIG. 4 illustrates a hot forming and primary quenching step including an electro-magnetic force according to an implementation of the instant application;

FIG. 5 illustrates a hot forming and primary quenching step including an explosive force according to an implementation of the instant application; and

FIG. 6 illustrates a hot forming and primary quenching step including an hydro-mechanical force according to an implementation of the instant application.

### DETAILED DESCRIPTION

In the following detailed description, various examples are presented to provide a thorough understanding of inventive concepts, and various aspects thereof that are set forth by this disclosure. However, upon reading the present disclosure, it may become apparent to persons of skill that various inventive concepts and aspects thereof may be practiced without one or more details shown in the examples. In other instances, well known procedures, operations and materials have been described at a relatively high-level, without detail, to avoid unnecessarily obscuring description of inventive concepts and aspects thereof

Stamping refers to the forming a workpiece (such as a sheet metal or blank) into a desired shape. During hot stamping, heating of the desired workpiece is generally performed in a furnace after which the workpiece is placed in a forming machine. Thus, one hot stamping process includes a series of independent operations such as heating, handling, and forming of the workpiece.

There are also die quenching methods in which a steel plate is heated to approximately 900° C., after which the steel plate is rapidly cooled while press-forming is performed and the formed product is quenched. Moreover, to heat the steel sheet, a continuous heating furnace that is provided separately from the press-forming apparatus is typically used. Another hot press-forming system employs a radiation heater, where the radiation heater is provided separately from the hot press-forming apparatus in the stage before the hot press-forming apparatus. Other methods include a conveyor that supports the metal material and conveys that material to the hot press mechanism by placing the middle section of the metal sheet that has been heated on forks, and driving the forks along in the conveyance direction. When conveying the metal material, because the material is only supported from beneath, the position of the metal material can shift. Thus, the positioning in the hot press mechanism takes greater time.

During hot press-forming, and particularly when holding both ends of heated workpiece to perform die quenching, the middle section of the work can ‘droop’. In some cases, for example when the holding force is very large, the workpiece can elongate in the lengthwise direction. A holding member can be used to hold the ends of the workpiece when conveying conduction heated work to help prevent or suppress thermal deformation of the workpiece. Thus, when conveying conduction heated work from an heating position to a processing position, interference between the workpiece and the parts of the conveyor apparatus can be prevented, and hot press-forming can be executed more quickly. Moreover, by conveying the work in a supported state, shifting of the workpiece position is inhibited, permitting an increase in the speed of conveying the workpiece from the energizing position to the processing position.

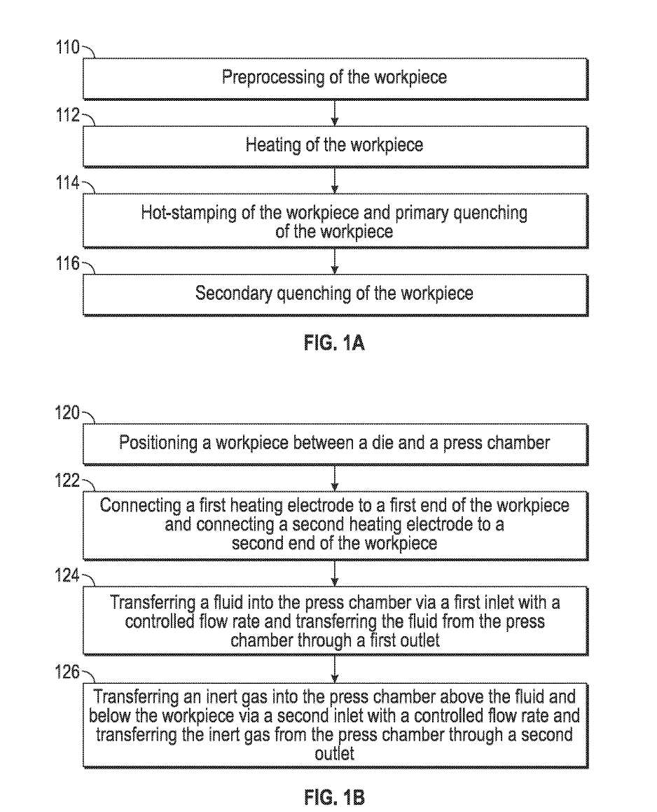

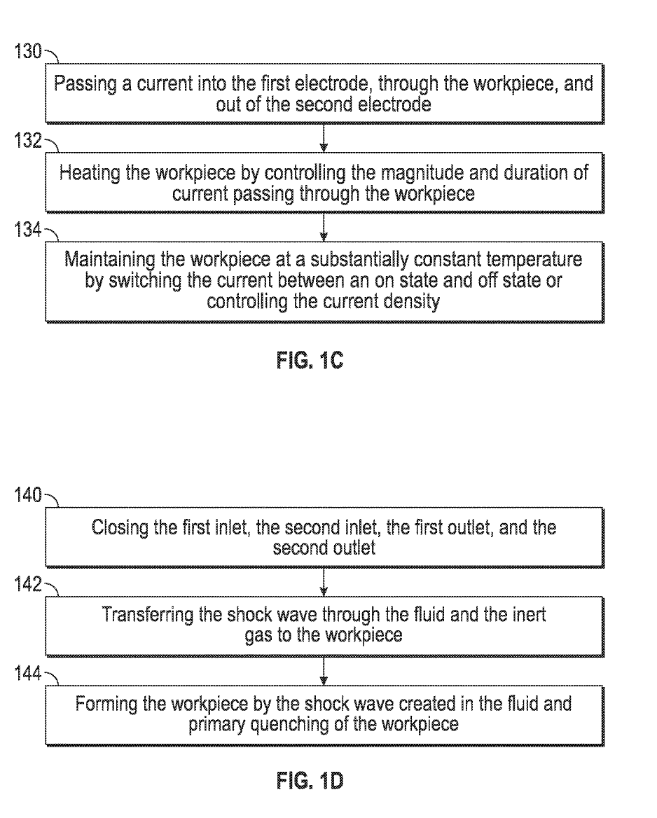

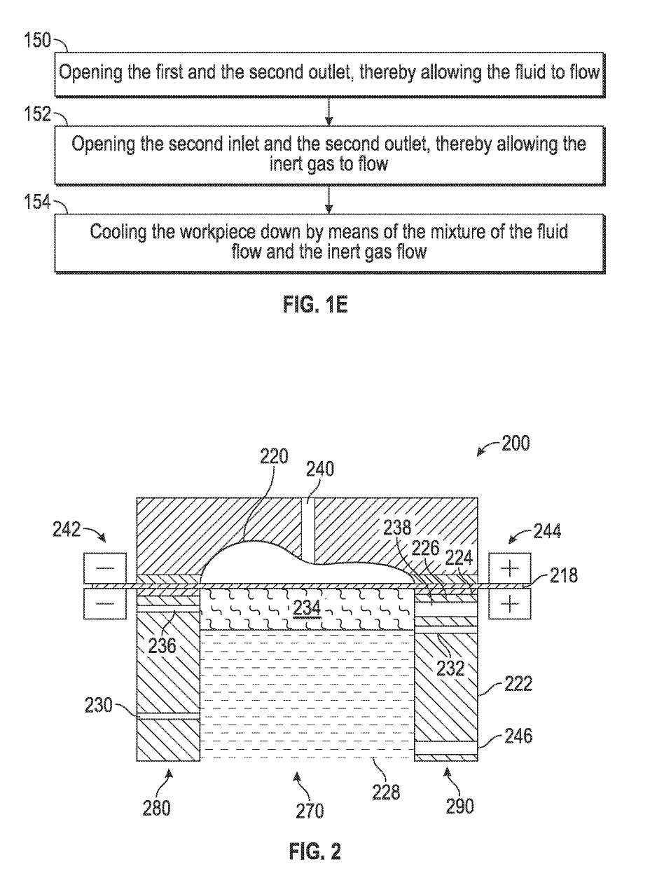

The present disclosure describes a high-speed hot forming and direct quenching system for metal sheet forming. FIGS. 1A-1E provide a series of flow charts of an implementation of a method of using the disclosed forming and quenching system. FIG. 1A illustrates an overview of an implementation of the method. Referring to FIG. 1A, a first step 110 can comprise various pre-processing steps that can prepare a workpiece for the apparatus. A second step 112 can involve a heating of the workpiece. A third step 114 comprises hot forming the workpiece and primary quenching of the workpiece. Furthermore, a fourth step 116 can comprise a secondary quenching of the workpiece. Additional details with respect to each of these steps is provided further below.

Referring to FIG. 1B, an implementation of a pre-processing step or method for a workpiece is illustrated in a flow chart. The method generally comprises a first step 120 of positioning a workpiece between a die and a fluid chamber, and a second step 122 of connecting a first heating electrode to a first end of the workpiece and a second heating electrode to a second end of the workpiece. A third step 124 comprises transferring a fluid into the fluid chamber. In one implementation, as discussed below, the fluid enters the fluid chamber via a first inlet and exits from a first outlet. In some implementations, the first inlet is located along a lower area of the first portion of the fluid chamber, and the first outlet is located on an upper area of the second portion of the fluid chamber. A fourth step 126 includes transferring an inert gas into the fluid chamber and the fluid level remains up to the level of the first outlet. In some cases, the inert gas enters the fluid chamber above the fluid level and below the workpiece. In one implementation, as will be discussed below, the inert gas flows into the fluid chamber via a second inlet and a second outlet. In some implementations, the second inlet is located above the fluid and on an upper area of the first portion of the fluid chamber and below the workpiece, and the second outlet is located along an upper area of the second portion of the fluid chamber and below the workpiece.

In FIG. 1C, an implementation of heating of the workpiece is illustrated in a flow chart. A first step 130 comprises passing a current into the workpiece. In one implementation, this can occur by passing through the first electrode, and out of the second electrode, where the first electrode is a negative electrode and the second electrode is a positive electrode. A second step 132 includes heating the workpiece by controlling the magnitude and duration of current passing through the workpiece. A third step 134 includes maintaining the workpiece at a substantially constant temperature by switching the current between an on state and an off state or controlling the current density.

Referring now to FIG. 1D, an implementation of a method of hot forming and primary quenching of the workpiece is illustrated in a flow chart. A first step 140 can include closing the first inlet, the second inlet, the first outlet, and the second outlet. In some implementations, each of the first inlet, the second inlet, the first outlet, and the second outlet can be closed in a substantially simultaneous manner. A second step 142 includes transferring hydraulic energy associated with the fluid and the inert gas to the workpiece. In a third step, the workpiece can be formed by pressing the workpiece to the die. In one implementation, the die is disposed above the workpiece.

In FIG. 1E, an implementation of a method of secondary quenching of the workpiece is illustrated in a flow chart. A first step 150 comprises opening the first inlet and the third outlet, thereby allowing the fluid to flow. In a second step 152, the second inlet and the second outlet are opened, thereby allowing the inert gas to flow. A third step 154 involves cooling the workpiece by means of the fluid flow and the inert gas flow. In other words, the fluid flow and the inert gas flow are configured to flow in such a manner so as to bring down the temperature associated with the workpiece.

Referring now to FIG. 2, for purposes of clarity, the basic portion of the high-speed hot forming and direct quenching system (“basic, portion”) 200 is depicted. In some implementations, the basic portion 200 may be understood to include a die 220, a fluid chamber 222, a thermal and electrical insulator 224, a fluid 228, a first inlet 230, a first outlet 232, an inert gas 234, a second inlet 236, a second outlet 238, a hole 240, a first heating electrode 242, a second heating electrode 244, and a third outlet 246. The fluid chamber 222 also includes an electrical insulator 226. The chamber 222 is shown in a cross-sectional view in FIG. 2 and as shown in this view, it includes a central region 270 and regions 280 and 290 surrounding the central region 270.

In some implementations, with reference to the pre-processing step described above (as introduced in FIGS. 1A and 1B), a workpiece 218 is placed, positioned, or disposed between the die 220 and the fluid chamber 222, either manually or automatically. In one implementation, by moving the die 220 downward, the workpiece 218 is locked in place. Thus, in different implementations, the distance between die 220 and the workpiece 218 can be adjusted.

Furthermore, it can be seen in FIG. 2 that in some implementations, a thermal and electrical insulator 224 are present, along both a first side and a second side of the workpiece 218. The thermal and electrical insulator 224 can be configured to protect the die and fluid chamber from overheating and/or damage by high temperature and current passing through the workpiece 218. In different implementations, the materials comprising the thermal and electrical insulator 224 should be flexible and be resistant to temperature shocks.

After the workpiece 218 has been positioned in the basic portion 200, in some implementations, fluid 228 flows into the fluid chamber 222 (as introduced in FIG. 1B above). In one implementation, a low flux or flow of fluid 228 enters the fluid chamber 222 via the first inlet 230. Excess fluid may exit via the first outlet 232 in a substantially constant manner, such that the fluid 228 flows continuously and remains at a constant temperature during the heating process. While the fluid 228 flows through the fluid chamber 222, inert gas 234 is injected into the space between the fluid 228 and the workpiece 218 through the second inlet 236 in one implementation. This process can act to remove the oxygen from the space between the workpiece 218 and the fluid 228, which may oxide and damage the workpiece during heating and hot forming and primary quenching processes described above. In some implementations, the inert gas 234 and the air can exit the space between the workpiece 218 and the fluid 228 via second outlet 238. In one implementation, in order to pull of oxygen out of the space between the workpiece 218 and the die 220, a vacuum pump (not shown) can be attached to the hole 240.

In different implementations, the heating step (as introduced in FIGS. 1A and 1C above) may utilize different methods, such as induction heating methods, resistive heating methods, industrial furnaces, and other heating methods. In one implementation, represented in FIG. 2, the heating step includes the use of a resistive heating apparatus. In this method, both ends of the workpiece 218 are attached to or placed in contact with two electrodes (represented in FIG. 2 as first electrode 242 and second electrode 244). In some implementations, the electrodes can include copper or other material with high conductivity. A high current can pass through the first electrode 242 and second electrode 244. The relatively high electrical resistivity of the workpiece 218, often a steel material, causes the workpiece 218 to be heated.

In some implementations, by adjusting the duration and the magnitude of current, a desired temperature can be achieved. In one implementation, the temperature of the workpiece 218 is measured by a sensor (not shown) associated with the workpiece 218 to help avoid overheating. Furthermore, a control system (not shown) can also be included in some implementations to regulate and/or maintain the temperature of the workpiece 218 during the heating step. In one implementation, the regulation may comprise switching the passing current through the first electrode 242 and the second electrode 244 from the on state to the off state and back to the on state repeatedly. In another implementation, the regulation may include controlling the passing current density through the first electrode 242 and the second electrode 244. It should be noted that in some implementation, the fluid 228 flows in a substantially continuous manner during both the pre-processing and the heating steps to maintain the fluid desired temperature. In addition, in one implementation, the first inlet 230 and the first outlet 232 are configured to close shortly or immediately before the hot forming and primary quenching process begins (as introduced in FIGS. 1A and 1D above). In one implementation, all inlets and outlets in the basic portion 200 close shortly before the hot forming and primary quenching step begins.

Thus, as indicated above, the hot forming and primary quenching step can follow the heating step. In one implementation, the hot forming and direct quenching processes occur inside the fluid chamber. In some implementations, the hot forming and primary quenching step may include a creation of a shock wave which propagates through the fluid 228 and the inert gas 234 in an upward direction. As a result, the shock wave propagated through the fluid 228 and the inert gas 234 can be used to push the workpiece 218 into or against the die 220 and form the workpiece 218 into the shape associated with the die 220.

The hot forming and primary quenching step is followed by the secondary quenching step (see also FIG. 1E above). During the secondary quenching step 116, the first inlet 230 and the second inlet 236 as well as the second outlet 238 can open to permit the fluid 228 and the inert gas 224 to flow with a higher flux. The high flux fluid 228 exits the fluid chamber 222 through the third outlet 246. In some implementations, the third outlet 246 and/or the second outlet 238 can be wider than either of the first inlet 230 and/or the second inlet 236. The turbulent flow regime of the fluid 228 and the inert gas 234 causes rapid quenching of the workpiece 218.

The secondary quenching step may be followed with any post processing treatments such as aging for aluminum workpieces and tempering for steel workpieces.

Thus, for purposes of clarity, the implementation of FIG. 2 can be understood to include a fluid chamber, where a series of hot forming and direct quenching processes occur inside the fluid chamber. The system also includes a die, where the die is located above the workpiece. In some implementations, the workpiece is configured to be disposed or positioned between the die and the fluid chamber. As shown in FIG. 2, the workpiece comprises a first end and a second end that are in contact with the press chamber. The system further includes two thermal and electrical insulators, where the thermal insulator are between workpiece and die and between workpiece and fluid chamber surface. In some implementations the thermal insulator covers all surfaces of the fluid chamber and die except their openings. The system also includes an electrical insulator, the electrical insulator being located between the thermal insulators and the fluid chamber and die, such that the electrical insulator covers all surfaces of the thermal insulators. The electrical and thermal insulators can be a single part that can isolate both thermally and electrically. The system may include an inert gas that is injected below the workpiece into the fluid chamber and a fluid that flows into the fluid chamber and below the inert gas. In one implementation, the system includes a first inlet, where the fluid flows into the fluid chamber through the first inlet, and where the first inlet is located on a lower area of a first portion of the fluid chamber, as shown in FIG. 2. In some implementations, the system includes a first outlet, through which the flow of fluid exits the fluid chamber, and where the first outlet is located on an upper area of a second portion of the fluid chamber (see FIG. 2). Furthermore, the system includes a second inlet through which the inert gas flows into the fluid chamber, where the second inlet is located above the fluid and on the upper area of the first portion of the fluid chamber and below the workpiece, as shown in FIG. 2. In addition, the system comprises a second outlet, through which the inert gas flows outside the fluid chamber, and where the second outlet is located along the upper area of the second portion of the fluid chamber and below the workpiece (see FIG. 2). In some implementations, the system further includes a first electrode, the first electrode attached to the first end of the workpiece, a second electrode, the second electrode being attached to the second end of the workpiece, and a third outlet, where the third outlet is located along the lower area of the second portion of the fluid chamber.

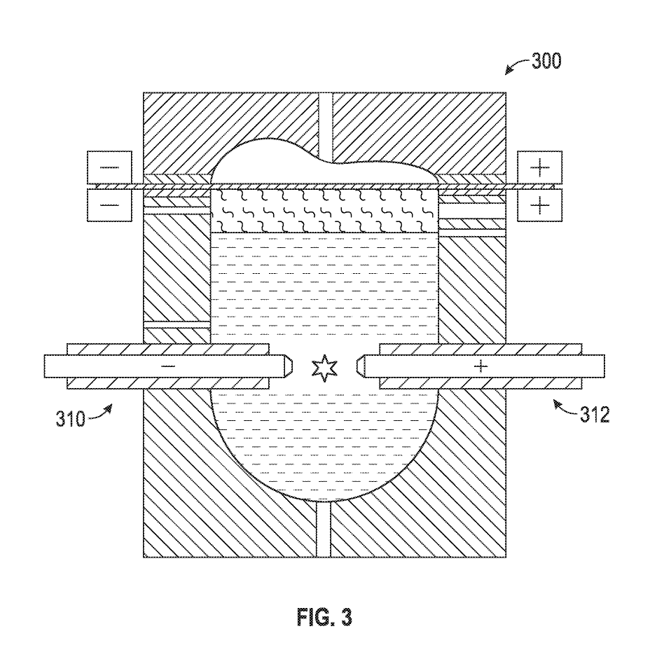

Referring now to FIG. 3, one implementation of the present application is illustrated, including a first high-speed hot forming and direct quenching system (“first system”) 300. In first system 300, the hot forming and primary quenching step (see FIGS. 1A and 1D) includes the use of an electro-hydraulic force. In systems that utilize an electrohydraulic process, a transformer charges high capacity capacitors. As shown in FIG. 3, the capacitors can provide a high voltage difference between a first electrode 310 and a second electrode 312, which forms a plasma thereafter or vaporizes the fluid between the electrodes. The expansion of plasma or vaporized fluid can create a sudden or abrupt shuck wave within the fluid and the inert gas, which in turn activates the hot forming process of the workpiece. It should be understood that first system 300 can also include any feature or component or process described herein with respect to FIG. 1, 2 or 4-6.

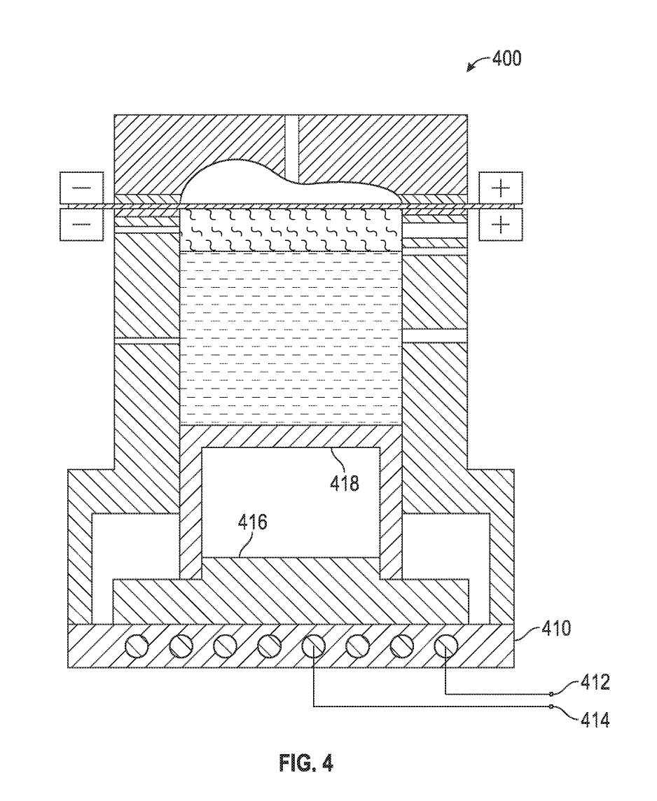

In FIG. 4, another implementation of the present application is illustrated, including a second high-speed hot forming and direct quenching system (“second system”) 400. In second system 400, the hot forming and primary quenching step comprises the use of an electromagnetic force. In systems that utilize an electromagnetic process, a transformer may be used to provide high voltage to capacitors. As shown in FIG. 4, the capacitors are suddenly discharged (through the use of a switch) to pass a high current through a substantially stationary coil (“coil”) 410, via a first wire 412 and a second wire 414. In one implementation, the coil 410 may be located inside of or within an insulating box. There is also a conductive plate 416 disposed on top of the coil 410. The strong electrical current can be discharged through the windings of the coil 410 to generate, momentarily, a strong electromagnetic field. The electromagnetic field induces an opposing electrical current in the conductive plate 416. As a result, the opposing magnetic fields between the coil 410 and the conductive plate 416 accelerate the conductive plate 416 and a piston 418 disposed above the conductive plate 416 to a high velocity. The sudden and rapid movement of the piston 418 presses or pushes the fluid and the inert gas inside the fluid chamber in a substantially spontaneous manner. In some cases, the shock wave of the pressed fluid and the inert gas transfers the force to the workpiece and moves the workpiece in a sudden motion toward the die, which forms the workpiece into the shape associated with the die. It should be also be understood that second system 400 can include any feature or component or process described herein with respect to FIGS. 1 and 2.

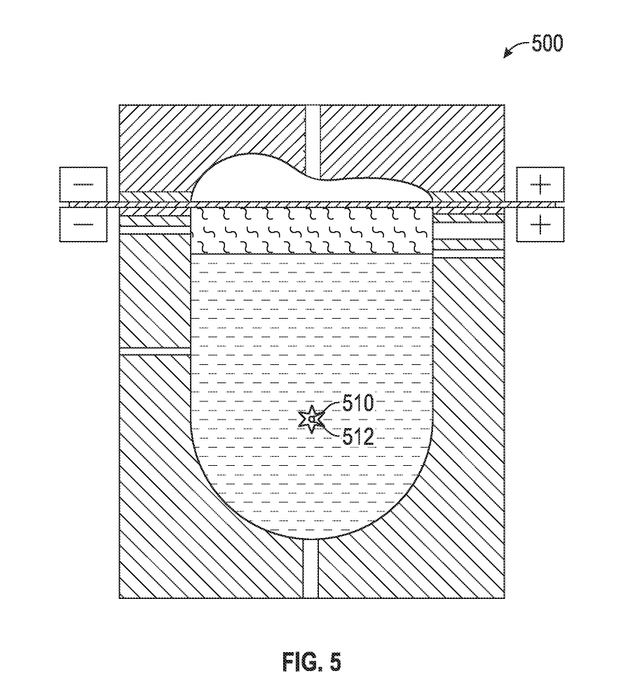

Referring now to FIG. 5, another implementation of the present application is illustrated, including a third high-speed hot forming and direct quenching system (“third system”) 500. In third system 500, the hot forming and primary quenching step comprises the use of an explosive force. In systems that utilize an explosive process, an appropriate explosive material is placed inside the fluid in the fluid chamber. As shown in FIG. 5, the fluid chamber is connected by a first wire 510 and a second wire 512 to an explosion-controlling system (not shown). The shock waves created by the controlled explosion transfer the hydraulic energy of the fluid and the inert gas to the workpiece, which in turn activates the hot forming process of the workpiece and the process of forming the workpiece into the shape of the die. It should be understood that third system 500 can also include any feature or component or process described herein with respect to FIGS. 1 and 2.

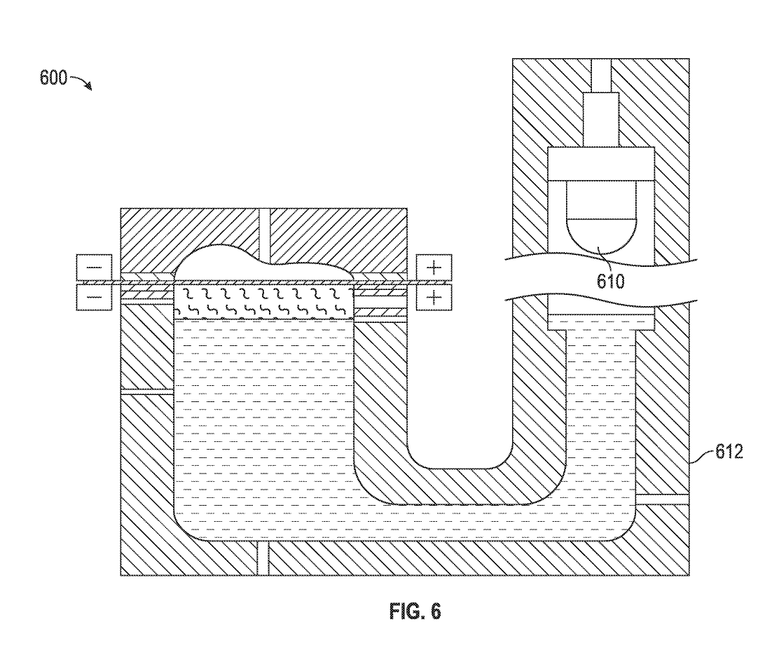

In FIG. 6, another implementation of the present application is illustrated, including a fourth high-speed hot forming and direct quenching system (“fourth system”) 600. In fourth system 600, the hot forming and primary quenching step comprises the use of a hydro-mechanical force. In systems that utilize a hydro-mechanical process, as shown in FIG. 6, a piston 610 moves rapidly in a downward direction inside a cylinder 612, which is connected to the fluid chamber. The hydro-mechanical force created by the piston 610 transfers to the fluid and the inert gas activates the hot forming process of the workpiece and the process of forming the workpiece into the shape of the die as described above. It should be understood that fourth system 600 can also include any feature or component or process described herein with respect to FIGS. 1-5.

Furthermore, in different implementations, the heating step disclosed herein can occur as a separate process. For example, the heating step can occur in a furnace, where the furnace is separate from the fluid chamber. In that case, the workpiece would be coated before the heat-treatment by an insulation layer to resist oxidation during the heat-treatment process. Furthermore, the insulation layer would be removed before the hot forming and primary quenching process begins. The workpiece may be transferred between the furnace and the fluid chamber manually or automatically. Moreover, because the fluid and the inert gas remain at a substantially constant temperature during the pre-processing and heat-treatment process, it should be understood that the workpiece begins to cool down upon hot forming via the fluid and the inert gas.

In another aspect of the present application, the method and the system presented may be used to form metal sheets other than iron and steel.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A high-speed hot forming and direct quenching system configured to form a workpiece, the system comprising:
a fluid chamber, wherein a series of hot forming and direct quenching processes occur inside the fluid chamber;
a die located above the workpiece and at an adjustable distance from the workpiece, wherein the workpiece is configured to be positioned between the die and the fluid chamber, and the workpiece includes a first end and a second end that are in contact with the fluid chamber;
a thermal insulator disposed along at least a portion of walls associated with the fluid chamber, wherein the thermal insulator includes a first end and a second end that are in contact with the fluid chamber, and the thermal insulator covers the first end and the second end of the workpiece;
an electrical insulator located between the thermal insulator and the fluid chamber, wherein the electrical insulator is disposed along at least a portion of the walls associated with the fluid chamber, and the electrical insulator covers the first end and the second end of the thermal insulator;
an, inert gas being injected below the workpiece into the fluid chamber;
a fluid configured to flow into the fluid chamber and below the inert gas
a first inlet, wherein the fluid flows into the fluid chamber through the first inlet, and the first inlet is located along a lower area of a first portion of the fluid chamber;
a first outlet, wherein the fluid exits the fluid chamber through the first outlet, and the first outlet is located along an upper area of a second portion of the fluid chamber;
a second inlet, wherein the inert gas flows into the fluid chamber through the second inlet, and the second inlet is located above the fluid and along the upper area of the first portion of the fluid chamber and below the workpiece;
a second outlet, wherein the inert gas flows outside the fluid chamber through the second outlet, and the second outlet is located along the upper area of the second portion of the fluid chamber and below the workpiece;
a first electrode configured to attach to the first end of the workpiece;
a second electrode configured to attach to the second end of the workpiece; and,
a third outlet located along the lower area of the second portion of the fluid chamber.

2. The system of claim 1, further comprising a hole, the hole being associated with the fluid chamber, wherein the hole is connected to a vacuum pump to conduct air outside of the fluid chamber, thereby minimizing the oxidation during the hot forming and direct quenching processes.

3. The system of claim 1, wherein the fluid is water.

4. The system of claim 1, wherein the workpiece is a steel sheet.

5. The system of claim 1, wherein the workpiece is a metal other than steel such as aluminum, magnesium, titanium, nickel.

6. The system of claim 1, wherein the second inlet is located above the fluid.

7. The system of claim 1, wherein the workpiece can be moved manually or automatically.

8. The system of claim 1, wherein the third outlet is wider relative to the first inlet and the second inlet.

9. A high-speed hot forming and direct quenching method, the method comprising:
a pre-processing step comprising:
positioning a workpiece between a die and a fluid chamber;
connecting a first electrode to a first end of the workpiece and connecting a second electrode to a second end of the workpiece;
transferring a fluid into the fluid chamber via a first inlet and out of the fluid chamber from a first outlet, the first inlet being located on along a lower area of a first portion of the fluid chamber, and the first outlet being located on an upper area of a second portion of the fluid chamber;
transferring an inert gas inside the fluid chamber above the fluid and below the workpiece via a second inlet;
transferring the inert gas out of the fluid chamber from the second outlet, the second inlet being located above the fluid and on an upper area of the first portion of the fluid chamber and below the workpiece;
a heating step comprising:
passing a current into the first electrode, through the workpiece, and out of the second electrode, the first electrode being a negative electrode and the second electrode being a positive electrode;
heating the workpiece by controlling a magnitude and duration of current passing through the workpiece;
maintaining the workpiece at a substantially constant temperature by switching the current between an on state and an off state;
a hot forming and primary quenching step comprising:
closing the first inlet, the second inlet, the first outlet, and the second outlet;
transferring hydraulic energy associated with the fluid and the inert gas to the workpiece;
forming the workpiece by pressing the workpiece to the die, the die being disposed above the workpiece;
a secondary quenching step comprising:
opening the first inlet and the first outlet, thereby allowing the fluid to flow;
opening the second inlet and the second outlet, thereby allowing the inert gas to flow; and
cooling the workpiece by means of the fluid flow and the inert gas flow.

10. The method, of claim 9 may be followed with any post processing treatments such as aging for aluminums and tempering for steels.

11. The method of claim 9, wherein the first inlet, the second inlet, the first outlet, and the second outlet are closed during the hot forming and primary quenching step.

12. The method of claim 9, wherein the hot forming and primary quenching step includes a hydro-mechanical method.

13. The method of claim 9, wherein the hot forming and primary quenching step includes an electromagnetic method.

14. The method of claim 9, wherein the hot forming and primary quenching step includes an electrohydraulic method.

15. The method of claim 9, wherein the hot forming and primary quenching step includes an explosive method.

16. The method of claim 9, wherein the heating step occurs in a furnace separate from the fluid chamber.

17. The method of claim 9, wherein the fluid is water,

18. The method of claim 9, wherein the workpiece is a steel sheet.

19. The method of claim 9, wherein the pre-processing step further comprises the first inlet being located on along a lower area of a first portion of the fluid chamber, and the first outlet being located on an upper area of a second portion of the fluid chamber.

20. The method of claim 9, wherein the pre-processing step further comprises the second inlet being located above the fluid and on an upper area of the first portion of the fluid chamber and below the workpiece, and the second outlet being located along the upper area of the second portion of the fluid chamber and below the workpiece.
